(19) United States
(12) Patent Application Publication
(10) Pub. No.: US 2009/0212939 A1
(43) Pub. Date: Aug. 27, 2009

(54) Dockable wireless remote control

(76) Inventor: Robert C. Richmond, Yucaipa, CA (US)

Correspondence Address: Robert C. Richmond, 33910 Golden Crown Way, Yucaipa, CA, 92399, US

(21) Appl. No.: 12/378,645

(22) Filed: Feb. 17, 2009

Related U.S. Application Data
(60) Provisional application No. 61/066,588, filed on Feb. 21, 2008.

(51) Int. Cl. G08C 19/16; G08B 1/08

(52) U.S. Cl. 340/539.11; 340/825.69

(57) ABSTRACT

Improvements in a portable hand-held radio frequency wireless remote control are disclosed. The dockable wireless remote control satisfies the need for a low cost compact portable remote control and can advantageously perform additional functions not performed by previous portable wireless remote control units. It can be carried by the user and used like a conventional remote control. It also enables software control of remote devices when connected (docked) to a computer by way of a direct electrical I/O connection. The proposed remote control provides a means to expand the capabilities of portable compact radio frequency wireless remote controls when needed for advanced control functions without significantly compromising their small size or low cost.

### CROSS REFERENCE TO RELATED APPLICATION

This application claims the benefit of Provisional Application 61/066,588 filed Feb. 21, 2008 the entire contents of which are hereby expressly incorporated by reference herein.

### FIELD OF THE INVENTION

This invention relates to improvements in portable hand-held radio frequency wireless remote controls.

### BACKGROUND OF THE INVENTION

Portable compact radio-frequency wireless remote controls are widely used for various applications and control purposes, such as automobile security systems, automobile door locks, residential and business security systems, garage door openers, lighting control, ceiling fan control, appliance control, general purpose on/off control, keyless entry, motorized window shades, HVAC control, etc. These hand-held remote controls have limited capabilities in order to keep them inexpensive, small and easily carried. Some are small and lightweight enough to be carried on a keychain or in a pocket. Generally only a few control buttons are provided to perform basic control functions. When a button is pushed on the remote control, a radio signal is transmitted wirelessly to the controlled device or system.

Remotely controlled devices and systems are becoming increasingly complex and capable. Many include microprocessor-based designs with advanced capabilities. Accordingly, for control of devices with advanced capabilities it would be useful to have more remote control capability than can be provided by a few buttons on a small remote control. At the same time, the size of the remote control should not be significantly increased, so that it can be conveniently carried by the user. For example, configuring the operation of the controlled device, setting operational sequences and schedules into the controlled device, retrieving various types of detailed information from the device, computer software control of the device, software display of data from the device, providing a graphic user interface to the controlled device, support of additional device functions, monitoring operation of the device, device test and diagnosis, are some of the advanced functions which cannot be performed by a simple remote control with only a few buttons. These advanced functions can also relate to systems which are connected to controlled devices.

Wireless remote control of devices with advanced capabilities such as those described above currently requires either a dedicated stand-alone wireless computer control interface or a bulky complex portable remote control unit.

Many variations of compact one-way wireless remote controls are known. But these have limited capabilities, in part because they do not have the ability to receive data from the controlled device.

U.S. Pat. No. 5,920,270, Security System Remote Control, John Peterson, Jul. 6, 1999, describes a one-way remote control for arming and disarming a security system. Such a remote control cannot retrieve information from the controlled security system, nor can it perform advanced functions similar to the examples listed above.

Two-way wireless remote controls are also known. Because the user interface must be completely contained within the remote control unit, capabilities are limited by the available space on the remote control unit, as well as by the cost and complexity of a user interface capable of performing the functions described above and displaying detailed information from the controlled device. A complex display can add to the size, weight, and power consumption of the remote control. The small size of a handheld remote control can make the display and user interface difficult to use. A backlight may be required to make the display visible under low-light conditions. Battery life may be shortened by the display, requiring the use of bulky, heavy batteries.

USB dongles (a USB dongle is a small device that connects to a host computer's USB port) are known which can provide software remote control capability when docked (connected) to a computer. But these have no remote control function when undocked. For example, ControlThink by Leviton Mfg. Co. offers a Z-Wave USB adapter for control of home automation devices. This is a dedicated computer, control interface which functions only when connected to a computer, so a separate portable remote control unit is needed for control without a computer.

Another type of dedicated computer control interface provides software remote control capability when docked to a computer, and can additionally be removed from the computer for purposes of network configuration. This allows the control unit to be carried to each device in a wireless network of devices and to add each device to the network. This is exemplified by the Z-Wave Primary Controller/PC Interface by HomeSeer Technologies LLC. This is a dedicated computer control interface which can perform operational device control functions only when connected to a computer. A separate portable remote control unit is needed for operational device control without a computer.

Remote control units which can be both handheld and docked to a computer are known, but these do not use the docking feature to provide a software controlled interface directly to the controlled device.

U.S. Pat. No. 6,255,961 B1, Two-way Communications between a Remote Control Unit and One or More Devices in an Audio/Visual Environment, Van Ryzin et al, Jul. 3, 2001, describes a two-way remote control unit which can retrieve information from an audio/video device. This remote control uses infra-red communication, which is generally not well suited for the applications listed above, and so is specific to controlling audio/video devices. This remote control must have a relatively large and complex display for the information from the controlled device. It can also communicate with a computer to obtain additional information to display. But it does not use computer software to provide direct device remote control functionality, and does not provide any control of non-audio/video devices. Direct computer control of a remote device can be impractical or even physically impossible when an infra-red remote control is docked to a computer because of line-of-sight limitations.

U.S. Pat. No. 6,211,870 B1, Computer Programmable Remote Control, William Foster, Apr. 3, 2001, describes software which can configure the display of a remote control when it is docked to a computer. This system does not provide software control of the controlled device when it is docked, and depends upon having a complex graphic display in the remote control.

U.S. Pat. No. 6,182,006, Navigation System Remote Control Unit with Data Caddy Functionality, James A. Meek, Jan. 30, 2001, describes a remote control which can be loaded with data from a computer, then carried into a vehicle, and transfer the data to the vehicle's navigation system. This remote control acts primarily as a data conveyance device for a navigation system. It is not used to directly perform wireless remote control functions by a user or by computer software.

U.S. Pat. No. 5,905,434, Vehicle Communication Device, Steffan et al, May 18, 1999, describes a remote control which can be loaded with messages from a computer, then carried to a vehicle. The messages can then be seen on a display unit on the vehicle. This remote control acts primarily as a data conveyance device. It is not used to directly perform wireless remote control functions by computer software when docked.

What is needed is a means to expand the capabilities of portable compact radio frequency wireless remote controls when required for advanced control functions without significantly compromising their small size or low cost.

### SUMMARY OF THE INVENTION

The present invention satisfies the need for a low cost portable compact remote control and can advantageously perform additional functions not performed by previous wireless remote control units. It can be carried by the user and used like a conventional remote control. It also enables software control of remote devices when connected (docked) to a computer by way of a direct electrical I/O connection. This then allows the host computer's software to utilize the wireless communication portion of the remote control unit, and thereby to accomplish either one-way or two-way direct communication with the controlled device. This can eliminate the need for a separate, dedicated, wireless control attachment at the computer. Furthermore, it enables a full-featured software interface to the controlled device when needed at little additional cost. A software application program allows a greater number of advanced device functions to be performed than can be accomplished solely using the buttons on the unit. As will be explained, this capability provides significant benefits in various applications.

### BRIEF DESCRIPTION OF THE DRAWINGS

FIG. 1 is an embodiment of a dockable wireless remote control with a USB docking connector and protective cover.

FIG. 2 is a block diagram illustrating components of the dockable wireless remote control shown in FIG. 1.

### DETAILED DESCRIPTION

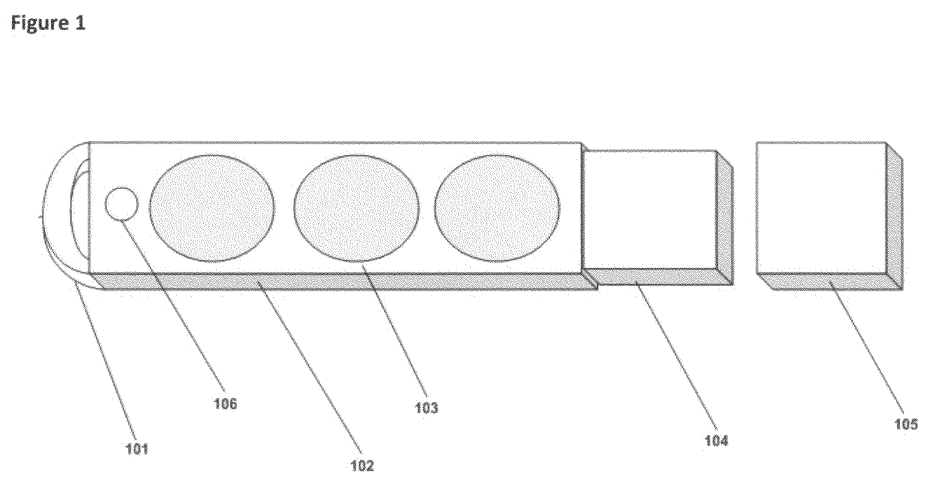

An embodiment of a dockable wireless remote control is shown in FIG. 1. In this embodiment, the shape and size of enclosure 102 is similar to that of a typical portable USB flash memory storage device, also sometimes referred to as a USB dongle (a small device that connects to a computer's USB port). It can be conveniently carried in the pocket of the user. An optional attachment point 101 allows the user to attach it to a keychain. One or more buttons 103 are provided to allow the user to perform the basic remote control functions required for a particular device. The unit can be docked (plugged in) to a host computer using USB connector 104. When docked, the user can perform advanced control functions with software resident on the host computer.

A cap 105 protects USB connector 104 from damage, improves the cosmetic appearance while undocked, and can additionally be used as a grip handle when the buttons 103 are being operated. In an alternate embodiment, the USB connector 104 can be retracted into the enclosure 102 when it is not needed, eliminating the need for cap 105.

There are various ways to connect external devices to a computer. Most computers today have USB ports (I/O or input/output connections) for external devices. This is a preferred connection for the present invention, since it can also provide power to the remote control. Alternatively, an RS232 serial port could be utilized for this purpose, or any other I/O port available on a computer. When docked, the present remote control unit may be used with or without a connecting cable. An external docking cradle which holds the remote control and connects it to the host computer could optionally be used. Thus the present invention can be either docked (connected to a computer), or undocked (removed for use as an operational portable device).

Other sizes and shapes of the enclosure 102 obviously can be utilized in alternate embodiments, as is preferred for the intended application. For example, the size and shape of a typical pocket automotive security alarm remote control can be used, with the addition of a docking port. More or fewer buttons 103 can be used, depending upon the needs of the application. Such form factors can be utilized as alternate embodiments provided they can house the buttons needed to perform the basic functions, as well as the computer connection needed for docking.

In another alternate embodiment, a larger portable remote control is used for applications requiring more buttons or a complex display capability when in the undocked condition.

The embodiment shown in FIG. 1 includes LED 106 for display of status. A more complex display capability may be included in an alternate embodiment. This can be in the form of one or more LEDs, a graphic LCD display, or other display device.

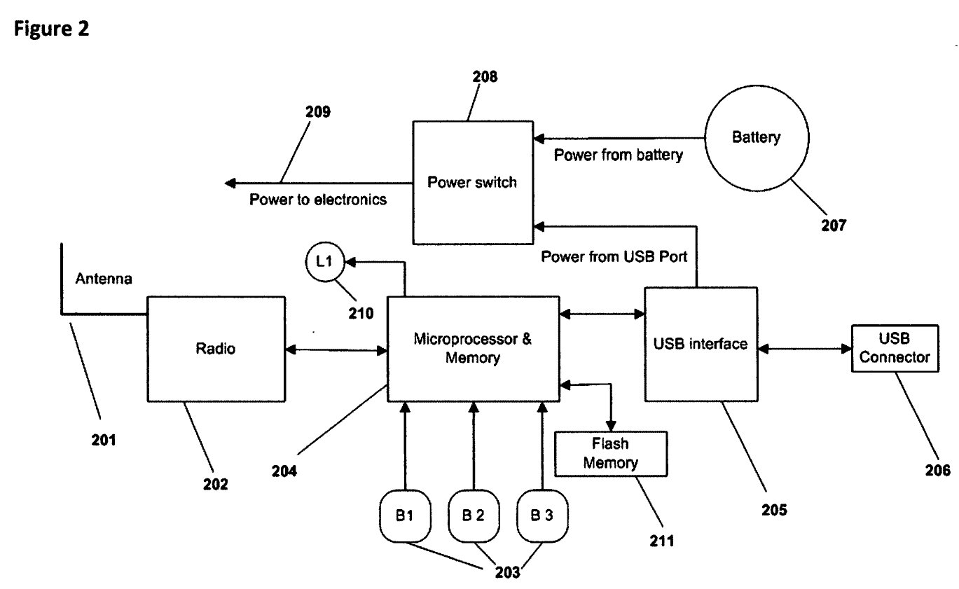

A suitable electrical block diagram of a dockable wireless remote control is shown in FIG. 2. In this embodiment, radio 202 provides two-way communication capability via antenna 201. The radio may be comprised of one or more integrated circuits and other related components. Various suitable off-the-shelf radio solutions are available, as is well known. For example, the Texas Instruments CC1101 implements a two-way radio on a single integrated circuit, as does the Microchip MRF24J40.

Antenna 201 can be implemented in various forms, as is well known. For example, a trace on the printed circuit board, a wire, or a chip antenna can be used.

Microprocessor 204 utilizes two-way radio 202 to communicate with the controlled system. Various suitable off-the-shelf microprocessor integrated circuits are available, such as the Texas Instruments MSP430, Microchip PIC, etc. Suitable microprocessor hardware and software techniques are well known and components are widely available.

The microprocessor 204 integrated circuit contains volatile and non-volatile memory for storage and execution of its program. This memory can optionally be read and written by the connected computer for purposes such as loading the program, transfer of data to or from remote devices, and general data storage. Non-volatile memory is typically in the form of internal flash memory or ROM. The illustrated embodiment utilizes rewriteable flash memory for non-volatile storage.

Flash memory 211 is rewriteable non-volatile memory. This optional component is used if microprocessor 204 does not contain flash memory or contains inadequate flash memory to perform the intended functions. This memory can optionally be read and written by the connected computer.

Buttons 203 are electrical pushbutton switches which allow the user to activate functions in the controlled device. LED 210 is an indicator which provides status information from the controlled device to the user. USB interface 205 provides an electrical interface to the host computer via USB connector 206.

The microprocessor 204 is programmed to access the radio 202, buttons 203, LED 210, USB interface 205, flash memory 211, as needed for the purpose of performing the intended functions of the remote control. These functions include sending wireless commands when the user presses a button, sending wireless commands under control of the USB interface when docked to a host computer, receiving data from the controlled device, storing data from the controlled device in memory, transferring data to or from memory under control of the USB interface when docked. Other functions may include error checking and error handling of wireless data, wireless message protocol, loading the microprocessor program from the host computer, and custom control functions, as needed for the intended application of the remote control. The functionality of the remote control can be customized and expanded with additions to the microprocessor's program using well known techniques and widely available software development tools.

The block diagram in FIG. 2 is not intended to limit the possible implementations or level of electronic integration, as there are many variations possible, and different applications of the present invention may better utilize a different implementation. Two or more of the functional blocks shown could be combined into a single integrated circuit in order to achieve a higher level of electronic integration, for example.

Most battery-powered compact portable remote control devices transmit only (one-way communication). The present invention can both transmit and receive (two-way communication) in order to fully access the advanced features of the controlled system. In this case, the controlled system would also have a two-way capability for purposes of accessing its advanced capabilities. In order to extend the battery life, however, the receive function in this embodiment is turned off when the remote control unit is removed from the computer (undocked).

Notwithstanding the previous explanation, the battery-powered portable remote control device could optionally operate in a two-way mode when undocked from a computer. For example, a button push would temporarily enable the receiver, allowing certain advanced capabilities or data in the controlled device to be accessed without a computer. To further illustrate this, in a security alarm application, for example, when the user pushes a button the remote control transmits a message to interrogate the controlled system to determine if it had detected an intrusion, and then displays the received intrusion status on the remote control unit (using LED 106 in the embodiment shown in FIG. 1). After the function completed, the receiver would be switched off by the microprocessor in order to extend the battery life. This is only one example, and is not intended to limit the possible uses of this capability.

The wireless communication frequency, method, and protocol used can be anything appropriate for the application. A typical handheld remote control application requires only a very low information bit rate for communication. Various low-bit-rate standard control protocols are in use today which could be utilized, for example IEEE 802.15.4, Z-Wave, Zigbee, Texas Instruments SimpliciTI, X10 Wireless, Insteon Wireless. Alternatively a custom wireless technique could be used, for example control code transmission via on/off keying, frequency shift keying, etc. At a minimum, the communication method must support the transfer of the messages needed for the intended application from the remote control to and from the controlled system.

A communication method and protocol suitable for the necessary basic and advanced control functions is performed by software within microprocessor 204 in conjunction with the capabilities of radio 202. One or more user-operated buttons 203 are provided which can be accessed by microprocessor 204. These buttons provide the basic control functions when the unit is undocked.

Remote controls generally use a communication security technique to insure controlling only the intended system. In a security alarm application, for example, this eliminates unauthorized arming and disarming from another remote control. A common technique uses a unique ID code which can be assigned to both the remote control unit and the controlled security system. This normally requires a one-time configuration process which “links” the remote control to a particular security system, using well known techniques. Once linked, a private wireless connection is established between the portable remote control and the security system, and messages not containing the unique ID code are ignored. In the present invention, this private linked connection can be utilized by either the buttons on the portable remote control (for the basic features), or by the computer software (for the advanced features). There is no need to establish separate linkage for each mode of use (docked or undocked) of the remote control. In addition, only the authorized user presumably has possession of the linked remote control, potentially minimizing any security risk associated with having a separate stand-alone linked remote control attached to a computer. And since the remote control unit is portable, a single linked remote control unit can be moved to any of different computers.

In this embodiment, a USB interface 205 allows the computer to communicate with microprocessor 204, and read and write the flash memory contained within microprocessor 204. This internal flash memory contains the executable program, configuration settings, and data to or from the controlled system. Various suitable off-the-shelf USB integrated circuits are available, such as the Future Technology Devices International Limited FT232BM, which perform the USB communications protocol. When the unit is docked to a computer, USB interface 205 allows the computer software to utilize radio 202 to perform advanced capabilities and control functions with the controlled system. When docked, USB connector 206 plugs into a computer connection, providing a communication link as well as a power connection with the computer.

Battery 207 is an energy storage device which provides power to the unit when it is undocked. It can be any suitable small battery, such as a lithium cell. In this embodiment, when the unit is docked, power is supplied by the computer so as to not discharge the battery. Power switch 208 provides power to the electronics 209 from either battery 207 or USB docking port connector 206. Power switch 208 switches over to USB power when it is available. Embodiments for other computer interfaces, such as an RS232 serial port, do not receive power from the computer, and therefore will not utilize power switch 208. In that case, battery 207 can provide power at all times, or power can be supplied externally.

In an alternate embodiment, battery 207 is a rechargeable battery. When the unit is docked, power from the USB is utilized to recharge the battery 207 via battery charging circuitry within the remote control. In yet another embodiment, a super-capacitor is used as an energy storage device in place of a battery.

Suitable electronics for a portable remote control are designed for very low power consumption when undocked. For example, microprocessor 204 and radio 202 may go into low power mode or be switched off when idle. Other power saving optimizations, as are well known, may be desired to maximize battery 207 life.

Other components not illustrated here may be desired for a particular control application and used in an alternate embodiment. For example, additional LED status indicators can be controlled by microprocessor 204 to provide status to the user.

A residential or business security alarm is an example of an application which can utilize the features of the present invention to advantage. A security system must be armed and disarmed by the user (the basic features) and can also be configured in various ways, report its operational status, etc. (the advanced features). This example will be explained in more detail to illustrate the operation and benefits of the present invention, but is not meant to limit the possible uses of the invention. In this example, a remote control of the embodiment illustrated in FIG. 1 is used to arm and disarm a residential security alarm. This remote control unit is small so it can be conveniently carried by the user when he leaves the premises. It would utilize, at a minimum, one button for arming and disarming the alarm. Using the arm/disarm button(s), the user arms the intruder alarm when leaving the premises, and disarms the alarm upon returning.

After the user arms the alarm, and after any exit delay, the security system could send a “system armed” confirmation signal to the remote control, which is displayed temporarily by the LED in the remote control. When the user returns and disarms the system with the remote control, the security system could send a signal to the remote control indicating that an intrusion has been detected (if any), which is also displayed temporarily by the LED in the remote control. This provides the user with a warning of a possible intruder before entering.

The controlled security system in this example has various advanced features, beyond the basic arm and disarm functions. Accessing these advanced features is beyond the capability of the buttons and LED on the remote control unit. For example, security system configuration, viewing the security system's event log, monitoring operational status, authorizing additional users, etc., may require connection to an external control unit or computer. There could be many other features, depending upon the system being controlled. Using the present invention, when the user needs to use those advanced functions, he can plug his remote control unit into a computer (via the USB port in this embodiment), thus providing the needed communication link between the computer and the controlled system.

Once docked to a computer, the computer can take control of the remote control's radio transmitter and receiver, and then utilize them for communication with the controlled security system, thereby eliminating the need for a separate, dedicated, computer wireless control attachment.

A software utility can be provided which allows the user to access all the advanced features of the security system. When the user wants to access the advanced features, he can dock his portable wireless remote control to the computer, and then run the software utility, which communicates wirelessly via the remote control. When the user only needs the basic capabilities provided by the buttons on the remote control, he can undock it from the computer, allowing him control of the basic features, such as, in this case, arm and disarm.

Other benefits are provided by this dual mode capability. When docked to a computer, software within the host computer, in conjunction with the microprocessor program within the remote control, could be used to redefine the use of the buttons for varying needs or different applications. This allows, for example, a single remote control hardware design to be used for multiple applications and purposes. Another possible use of this capability is to limit the number of “uses” (button pushes or received signals) of the remote control before disabling one or more of its basic functions in the undocked mode. In the security alarm system application described here, a remote control could be configured to allow guest access for a limited number of times. Additionally, a personal security code could be programmed into the remote control unit which is transmitted to the security system for selective access control and logging.

Once docked to a computer, it can be easily seen that the full power of the computer is available to perform many different functions in conjunction with the wireless remote control and the controlled system.

The wireless dockable remote control could also be used as a data collection and conveyance device. When operated undocked in the two-way mode, it could record data from one or more controlled devices or systems. These devices or systems may be out of wireless range of a computer. In this case, the user can push a button on the remote control (when in range of the controlled system) which sends a message to interrogate the remote device, and the device responds with the desired data. After receiving the data and saving it in its internal memory, the remote control unit could be docked with a computer, and the collected data could then be retrieved by software via the docking port.

Another embodiment includes the addition of a useful amount of flash memory 211 read/write data storage to the embodiment illustrated in FIG. 1. Such an embodiment could be made to function as a USB data storage drive in addition to functioning as a remote control. Since the form factor of the embodiment illustrated in FIG. 1 is similar to that of a typical portable USB flash memory storage device, it would be well suited for use as such. Many people carry USB keychain data storage drives for general data storage purposes. Adding this function to the remote control unit could add to its utility and convenience by eliminating the need for a user to carry a separate USB data storage drive.

The application examples described here illustrate possible uses of the present invention and are not intended to limit its possible uses on other wireless remote controlled systems. There are many useful applications for a dockable wireless remote control, especially for controlling systems which have both button-activated basic features and computer-enabled advanced features, such as energy management systems, irrigation controllers, appliance controllers, home automation systems, etc.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention. It is intended that the foregoing detailed description be regarded as illustrative rather than limiting and that it is understood that the following claims including all equivalents are intended to define the scope of the invention.

What is claimed is:

1. A portable remote control unit, comprising:
a radio frequency transmitter and receiver for wireless communication between the remote control unit and the controlled device or system;
an energy storage device which provides power to the remote control unit when power is not externally supplied;
one or more buttons which are operated by the user for activating remote control functions in the controlled device or system;
an electrical I/O communication interface which can be connected to a host computer's I/O port,
wherein said portable remote control unit is capable of operating as a wireless control interface to remote devices or systems using said buttons operated by the user, and is capable of operating as a wireless control interface to remote devices or systems under host software control when connected to said host computer's I/O port, and
wherein said portable remote control unit is capable of controlling by means of said buttons at least one of the operational functions provided by the controlled device or system for its intended application and use.

2. The portable remote control unit of claim 1, wherein said remote control's electrical I/O communication interface comprises a universal serial bus USB connector and USB interface electronics.

3. The portable remote control unit of claim 1, wherein said remote control's transmitter and receiver is utilized by computer software for control of remote devices or systems when said remote control is docked to a computer.

4. The portable remote control unit of claim 1, wherein said remote control is used for control of certain operational features in the controlled device or system by means of said buttons when undocked from a computer and for control of additional features in the controlled device or system by means of computer software when said remote control is docked to a computer.

5. The portable remote control unit of claim 1, wherein said remote control receives its power from a computer instead of from said energy storage device when said remote control is docked to a computer.

6. The portable remote control unit of claim 1, wherein said remote control further comprises one or more indicators for display of status received from the controlled device or system.

7. The portable remote control unit of claim 2, wherein said energy storage device is a rechargeable battery which provides power to said remote control unit when it is undocked, and is recharged by means of said USB connector when it is docked to a computer.

8. The portable remote control unit of claim 1, wherein said remote control is used to control the operation of remote devices or systems as a replacement for a separate, dedicated wireless control unit attached to a computer.

9. The portable remote control unit of claim 1, wherein said remote control unit has the capability to be linked with the controlled device or system in order to restrict access from remote control units which have not been so linked.

10. The portable remote control unit of claim 1, wherein said remote control, when docked to a computer, has the capability to be configured by the computer to redefine said button functions and to redefine control functions when undocked.

11. The portable remote control unit of claim 1, wherein said remote control, when docked to a computer, has the capability to be configured to limit specific control operations to a predetermined number of uses when it is undocked.

12. The portable remote control unit of claim 1, wherein said remote control, when docked to a computer, has the capability to be configured to transmit a predetermined personal security code to the controlled device or system when it is undocked.

13. The portable remote control unit of claim 1, wherein said remote control has the capability to cause the controlled device or system to transmit data back to said remote control, which receives the information and stores it for conveyance to computer software when it is docked to a computer.

14. The portable remote control unit of claim 13, wherein said remote control has the capability to wirelessly extract data from a controlled device or system when it is undocked and store it for transport it to a distant computer which is out of wireless transmission range of the controlled device or system.

15. The portable remote control unit of claim 2, wherein said remote control further comprises flash memory for storing data which can be written and read by means of said USB connector.

16. The portable remote control unit of claim 15, wherein said remote control functions as a removable data storage drive when said flash memory is accessed by a host computer using said USB connector.

17. The portable remote control unit of claim 2, wherein a removable cover slides over said USB connector and acts as a protective cap.

18. The portable remote control unit of claim 17, wherein said cover has the capability to be used as a handle while the user operates the remote control buttons.

19. The portable remote control unit of claim 1, wherein said remote control is capable of enabling full operational power to its wireless receiver for only a time adequate to receive a response from the controlled device or system after it transmits a control signal to the controlled device or system.

20. The portable remote control unit of claim 19, wherein said remote control extends the available energy life from said energy storage device by enabling its receiver only when needed to receive expected transmissions from the controlled device or system.
